(19) United States
(12) Patent Application Publication
(10) Pub. No.: US 2008/0022580 A1
(43) Pub. Date: Jan. 31, 2008

(54) Lure trolling device

(76) Inventor: Robyn L. Moulder, Gold Hill, OR (US)

Correspondence Address: LAW OFFICE OF GERALD D. HAYNES, 2 NORTH OAKDALE AVENUE, MEDFORD, OR, 97501, US

(21) Appl. No.: 11/495,375

(22) Filed: Jul. 28, 2006

(51) Int. Cl. A01K 91/08

(52) U.S. Cl. 43/43.12; 43/43.13

(57) ABSTRACT

A lure trolling device is disclosed. An illustrative embodiment of the lure trolling device includes a body having an elongated main panel and an end panel disposed at a generally obtuse angle with respect to the main panel, an elongated rail carried by the body, a flexible tail hook carried by the rail and a guide wire carried by the rail.

### FIELD

The present invention relates to fishing accessories. More particularly, the present invention relates to a lure trolling device which can be used to trail a lure in a water body from a pier, bank or boat.

### BACKGROUND

Freshwater and saltwater fishing is a popular pastime for millions of persons worldwide. Typically, cast fishing is carried out by tying a lure or bait on a fishing line which is wound on a reel provided on a flexible fishing rod. The lure or bait is cast into a water body from a pier, bank or boat by tossing the rod in a forward motion while depressing a button or after releasing a bail on the rod. The lure or bait is either reeled in or allowed to sit for a period of time in order to attract fish. Fly fishing involves repeated tossing of a fishing line into a river to elicit a fish strike. In flowing bodies of water such as rivers, it is sometimes desirable to allow the lure to trail in the water from a fishing rod on the bank or in a boat.

### SUMMARY

The present invention is generally directed to a lure trolling device. An illustrative embodiment of the lure trolling device includes a body having an elongated main panel and an end panel disposed at a generally obtuse angle with respect to the main panel, an elongated rail carried by the body, a flexible tail hook carried by the rail and a guide wire carried by the rail.

### BRIEF DESCRIPTION OF THE DRAWINGS

The invention will now be described, by way of example, with reference to the accompanying drawings, in which:

FIG. 1 is a top view of an illustrative embodiment of the lure trolling device;

FIG. 2 is a side view of an illustrative embodiment of the lure trolling device;

FIG. 3 is an opposite side view of an illustrative embodiment of the lure trolling device;

FIG. 4 is a front perspective view of an illustrative embodiment of the lure trolling device;

FIG. 5 is an exploded, front perspective view of an illustrative embodiment of the lure trolling device, illustrating typical attachment of an outrigger element to a body element of the device;

FIG. 6 is an enlarged sectional view illustrating attachment of a quick release clip to the body element of an illustrative embodiment of the lure trolling device and a fishing line (in section) to the quick release clip in a typical offshore release method for trailing a lure (not shown) behind the device in typical application; and

FIG. 7 is a front perspective view of an illustrative embodiment of the lure trolling device, more particularly illustrating a typical cast-over method for trailing a lure behind the device in typical application.

### DETAILED DESCRIPTION

Referring to the drawings, an illustrative embodiment of the lure trolling device, hereinafter device, is generally indicated by reference numeral 1. The lure trolling device 1 includes a body 2 which is a buoyant material such as wood or plastic, for example. The body 2 includes a main panel 3 which may have a generally elongated, rectangular shape. For purpose of description herein, the main panel 3 has a pair of elongated, parallel, spaced-apart longitudinal edges 3a; a first end edge 3b and a second end edge 3c; and first and second surfaces 3d and 3e, respectively. An end panel 4 extends from the first end edge 3b of the main panel 3 and is disposed generally adjacent and at a generally obtuse angle with respect to the first surface 3d of the main panel 3. The end panel 4 may be continuous with the main panel 3 or may be attached to the main panel 3 using techniques which are known to those skilled in the art.

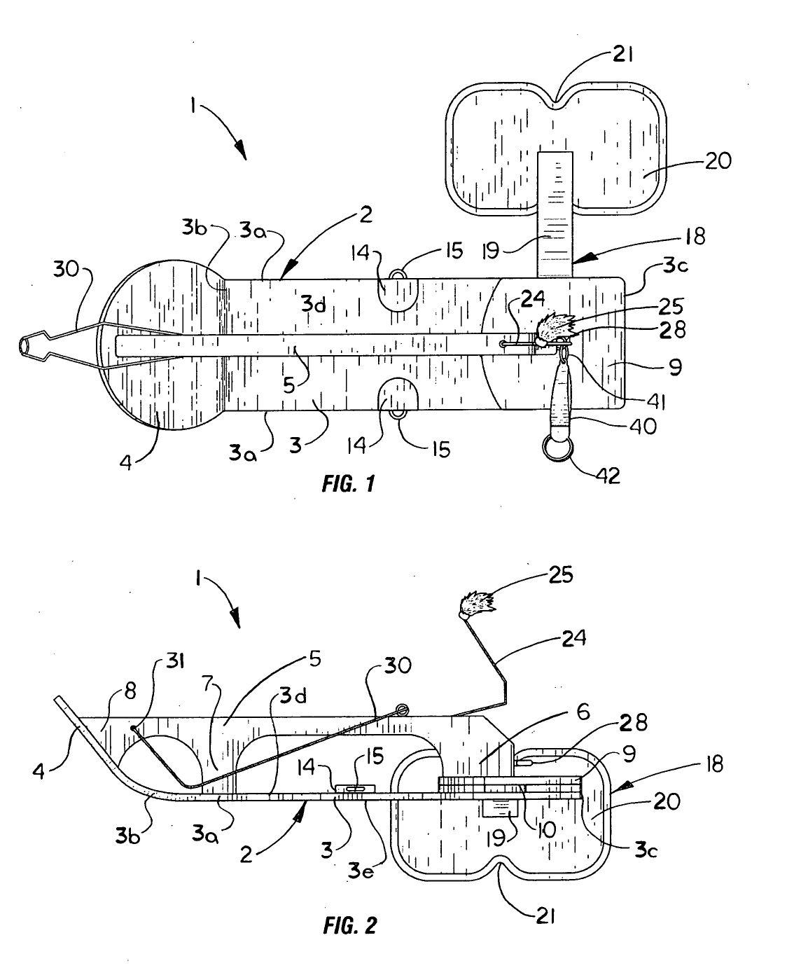

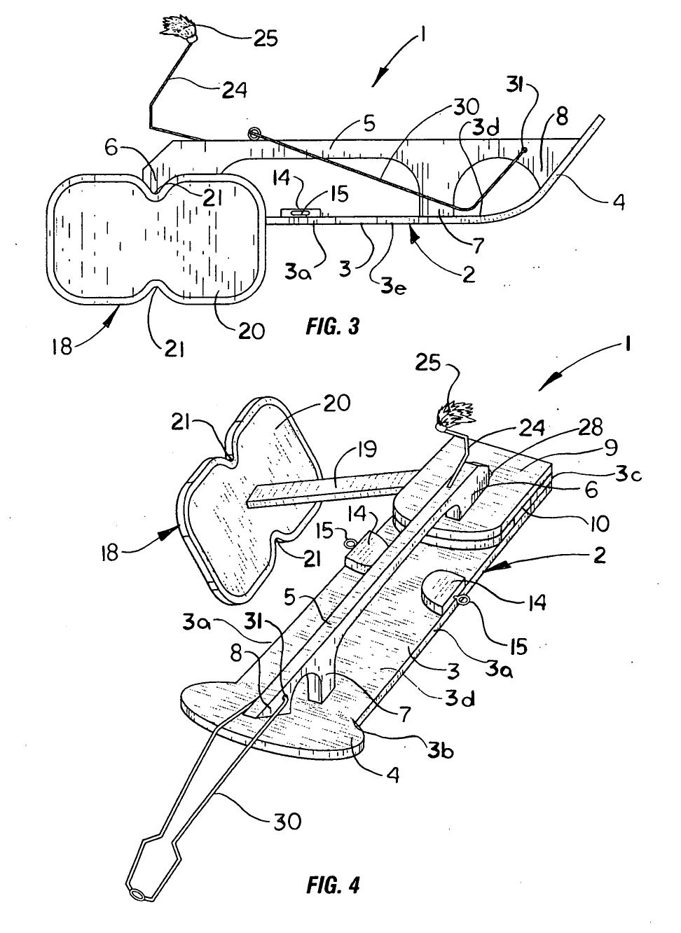

At least one tether hook 15 is typically provided on the main panel 3 of the body 2. As illustrated in FIG. 1, in some embodiments of the device 1, the at least one tether hook 15 is provided at a longitudinal edge 3a of the main panel 3. In some embodiments of the device 1, a tether hook 15 is provided at each longitudinal edge 3a of the main panel 3. A tether hook anchor 14 may be provided on the main panel 3, such as on the first surface 3d of the main panel 3, for example, in which case the tether hook 15 extends from the tether hook anchor 14.

An elongated rail 5 is provided on the main panel 3 of the body 2. As illustrated in FIG. 1, when the device 1 is viewed from above, the rail 5 typically extends substantially midway between and parallel to the longitudinal edges 3a of the main panel 3. At least one rail support may extend from the body 2 to attach the rail 5 to the body 2. For example, as illustrated in FIGS. 2, 4 and 5, a rail support 6 and a rail support 7 may extend from the first surface 3d of the main panel 3 to support the rail 5 in spaced-apart relationship with respect to the main panel 3. A rail support 8 may extend from the end panel 4 to attach the rail 5 to the end panel 4. As further illustrated in FIGS. 2, 4 and 5, in some embodiments, a rail support platform 9 is provided on the first surface 3d of the main panel 3, typically adjacent to the second end 3c. The rail support 6 typically extends from the rail support platform 9.

An outrigger 18 extends from the body 2 of the device 1 to maintain the body 2 in an upright position in a body of water 44, such as a moving stream or river as illustrated in FIG. 7 and will be hereinafter described. The outrigger 18 typically includes an elongated outrigger shaft 19 which extends from the body 2. As illustrated in FIG. 2, the outrigger shaft 19 typically extends generally adjacent and at an obtuse angle with respect to the second surface 3e of the main panel 3 of the body 2. An outrigger plate 20 is provided on the distal or extending end of the outrigger shaft 19. The plane of the outrigger plate 20 is disposed at a generally 90-degree angle with respect to the longitudinal axis of the outrigger shaft 19. Plate notches 21 may be provided in opposite edges of the outrigger plate 20.

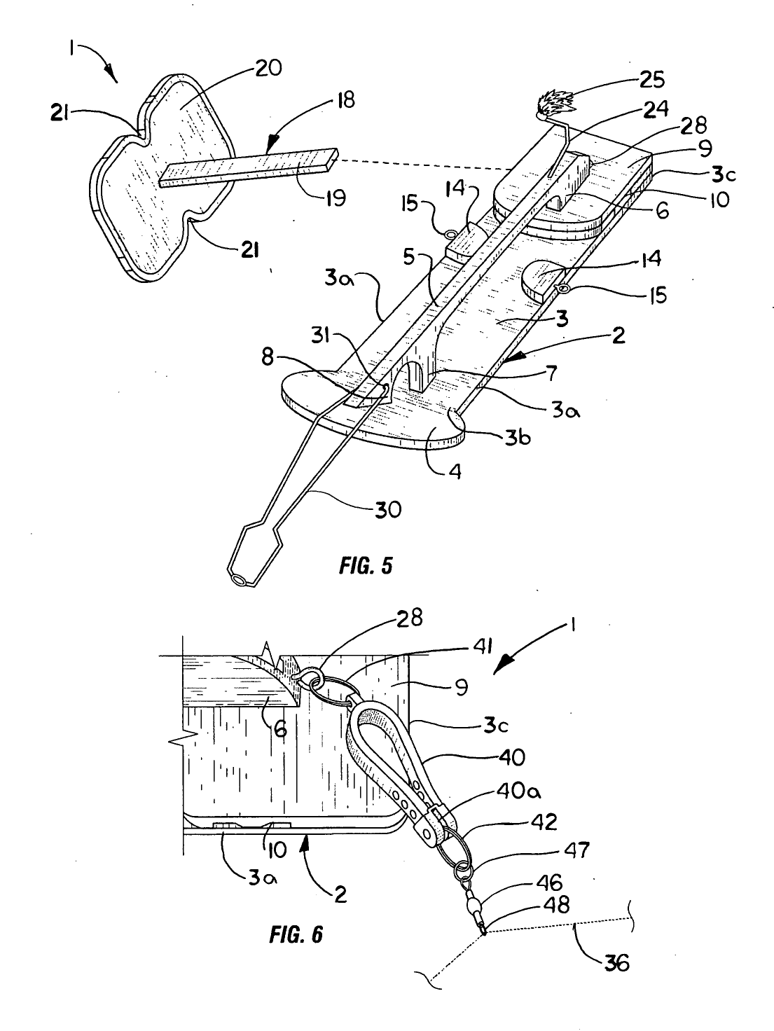

The outrigger 18 may be detachably connected to the body 2 of the device 1 using any suitable technique known to those skilled in the art. In some embodiments of the device 1, the outrigger 18 can be selectively attached to either side of the body 2, as illustrated in FIG. 5. For example, as illustrated in FIGS. 2 and 4, an outrigger slot 10 may be provided in each side of the rail support platform 9, which case the outrigger shaft 19 is inserted in the outrigger slot 10.

A tail hook 24, the purpose of which will be hereinafter described, extends from the rail 5, typically adjacent to the rear rail support 6. The tail hook 24 has a generally concave shape, the concavity of which faces the end panel 4 of the body 2. A skirt 25, which is typically a bright color, may be provided on the tail hook 24 to enhance visibility of the tail hook 24. As illustrated in FIG. 2, a clip attachment hook 28, the purpose of which will be hereinafter described, may be provided typically on the rear rail support 6. A guide wire 30 may be attached to the rail 5 for purposes which will be hereinafter described. The guide wire 30 may be pivotally attached to the rail 5, such as by extending the guide wire 30 through a guide wire opening 31 provided in the rail 5, for example.

Referring next to FIG. 7 of the drawings, typical use of the device 1 in a cast-over method for trailing a fishing lure 37 behind the device 1 in typical application is shown. Accordingly, the fishing lure 37 is tied on the end of a fishing line 36 which is wound on a reel (not illustrated) of a fishing rod (not illustrated). The outrigger 18 is attached to the body 2 typically by inserting the outrigger shaft 19 of the outrigger 18 in one of the outrigger slots 10. The body 2 of the device 1 is tethered to a boat (not illustrated) floating on a water body 44, or alternatively, to a support (not illustrated) such as a tree, stake or the like on a shore (not illustrated) of a water body 44. This is accomplished by attaching one end of a tether line 34, which may be DACRON (trademark), for example, to one of the tether hooks 15 provided on the body 2. The opposite end (not illustrated) of the tether line 34 is attached to the boat (not illustrated) or support (not illustrated). With the guide wire 30 pivoted to the forwardly-extending position illustrated in FIG. 7, the device 1 is then placed on the water body 44, with the outrigger 18 extending into the water body 44. Accordingly, the water body 44 applies pressure against the outrigger plate 20 of the outrigger 18 to push the device I against the tension applied by the tether line 34. Therefore, the device 1 floats or planes on the surface of the water body 44, typically in the center of the water body 44, as the tether line 34 tethers or moors the device 1 to the boat or support. The position of the device 1 in the water body 44 can be adjusted by adjusting the length of the tether line 34.

Next, the fishing lure 37 is cast into the water body 44 upstream of the device 1 such that the current of the water body 44 carries the fishing line 36 into contact with the guide wire 30. Consequently, the guide wire 30 guides the fishing line 36 along the rail 5, which ultimately causes the fishing line 36 to hang on the tail hook 24, as illustrated. Therefore, the fishing lure 37 trailed behind the device 1 by the flowing current of the water body 44. In the event that a fish (not illustrated) strikes the fishing lure 37, the flexible tail hook 24 releases the fishing line 36, enabling the fish to be reeled in on the fishing rod. While it is engaged by the tail hook 24, the fishing line 36 can be lengthened or shortened on the fishing rod (not illustrated) since the fishing line 36 can freely slide in either direction on the tail hook 24 without snagging.

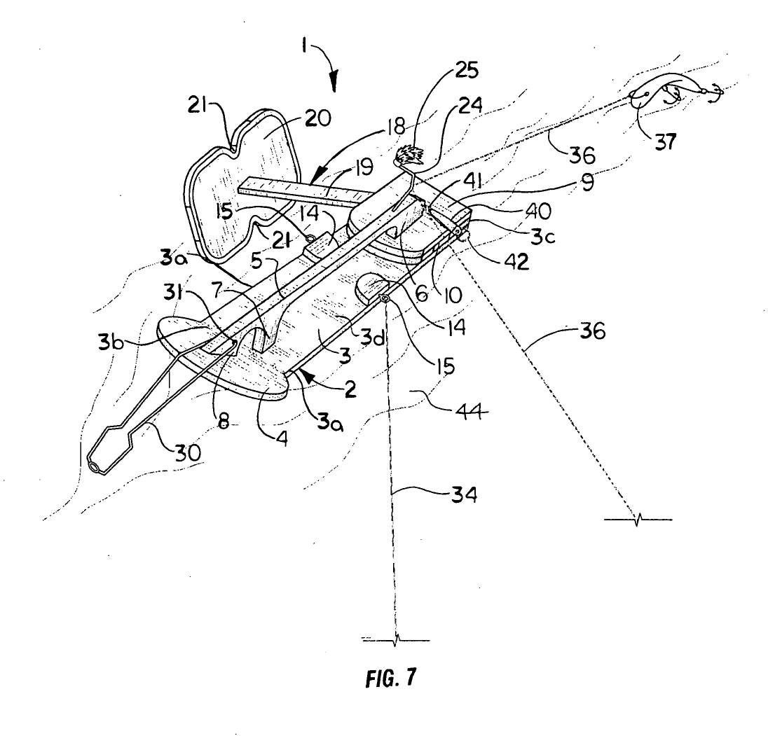

Referring next to FIG. 6 of the drawings, typical use of the device 1 in an offshore release method for trailing a fishing lure (not illustrated) behind the device 1 is illustrated. Accordingly, a quick release clip 40 of selected design detachably connects the fishing line 36 to the device 1. The quick release clip 40 is attached to the clip attachment hook 28 on the rear rail support 6 of the body 2 such as by an attachment ring 41. In some embodiments, the quick release clip 40 has a ring slot 40a into which a clip ring 42 is snap-fitted. One end of a swivel 46 is attached to the clip ring 42 by a swivel ring 47. A line clip 48 is attached to the other end of the swivel 46. Instead of being cast over the tail hook 24 as was the case with regard to the cast-over method which was heretofore described with respect to FIG. 7, the fishing line 36 is attached to the line clip 48, as illustrated in FIG. 6, with the fishing lure (not illustrated) trailing behind the device 1 as the device 1 floats or planes of the water body 44, as was heretofore described with respect to FIG. 7. Accordingly, in the event that a fish (not illustrated) strikes the fishing lure (not illustrated), the clip ring 42 is released from the quick release clip 40, thereby enabling the fish to be reeled in on the fishing rod. It is to be understood that the quick release clip 40 and other attachment elements which are shown in FIG. 6 are illustrative only and may be replaced by any suitable mechanism which facilitates detachable attachment of the fishing line 36 to the device 1.

It will be appreciated by those skilled in the art that the device 1 enables a user to troll into the center or channel of any moving water body such as a stream or river whether the water body is moving in a fast or slow current. When the device 1 is floated out into a river and tethered to a fisherman's rod holder (not illustrated) or a nearby tie-down (not illustrated) such as a tree or rock, for example, it holds its position in the current without wandering or zigzagging. This eliminates the need for the user to repeatedly cast and reel in the fishing line 36 in order to place the fishing lure 37 at the desired location in the water body 44.

While the preferred embodiments of the invention have been described above, it will be recognized and understood that various modifications can be made in the invention and the appended claims are intended to cover all such modifications which may fall within the spirit and scope of the invention.

What is claimed is:

1. A lure trolling device, comprising:
a body having an elongated main panel and an end panel disposed at a generally obtuse angle with respect to said main panel;
an elongated rail carried by said body;
a flexible tail hook carried by said rail; and
a guide wire carried by said rail.

2. The lure trolling device of claim 1 further comprising a skirt carried by said tail hook.

3. The lure trolling device of claim 1 further comprising a clip attachment hook provided on said body.

4. The lure trolling device of claim 1 further comprising at least one tether hook carried by said main panel of said body.

5. The lure trolling device of claim 4 further comprising at least one tether hook anchor provided on said main panel and wherein said at least one tether hook extends from said at least on tether hook anchor.

6. The lure trolling device of claim 1 wherein said guide wire is pivotally carried by said body.

7. The lure trolling device of claim 1 further comprising an outrigger extending from said body.

8. The lure trolling device of claim 7 wherein said outrigger comprises an elongated outrigger shaft extending from said body and an outrigger plate carried by said outrigger shaft.

9. A lure trolling device, comprising:
a body having an elongated main panel and an end panel disposed at a generally obtuse angle with respect to said main panel;
at least one rail support extending from said main panel;
an elongated rail carried by said at least one rail support;
a flexible tail hook carried by said rail;
a guide wire carried by said rail; and
an outrigger having an outrigger shaft extending from said body and an outrigger plate carried by said outrigger shaft.

10. The lure trolling device of claim 9 further comprising a skirt carried by said tail hook.

11. The lure trolling device of claim 9 further comprising a rail support platform carried by said main panel and wherein said at least one rail support comprises a first rail support extending from said rail support platform and a second rail support extending from said main panel in spaced-apart relationship with respect to said first rail support.

12. The lure trolling device of claim 11 wherein said at least one rail support further comprises a third rail support extending from said end panel.

13. The lure trolling device of claim 11 further comprising at least one outrigger slot provided in said rail support platform and wherein said outrigger shaft of said outrigger is inserted in said at least one outrigger slot.

14. The lure trolling device of claim 11 further comprising a clip attachment hook provided on said first rail support.

15. The lure trolling device of claim 9 further comprising at least one tether hook carried by said main panel of said body.

16. The lure trolling device of claim 15 further comprising at least one tether hook anchor provided on said main panel and wherein said at least one tether hook extends from said at least on tether hook anchor.

17. A lure trolling device, comprising:
a body including a generally elongated, rectangular main panel having a pair of longitudinal edges and first and second end edges extending between said pair of longitudinal edges and an end panel extending from said first end edge and disposed at a generally obtuse angle with respect to said main panel;
a rail support platform carried by said main panel generally adjacent to said second end edge;
a first rail support extending from said rail support platform;
a second rail support extending from said main panel in spaced-apart relationship with respect to said first rail support;
an elongated rail carried by said first rail support and said second rail support;
a flexible tail hook carried by said rail;
a guide wire carried by said rail;
first and second tether hooks carried by said main panel at said pair of longitudinal edges, respectively;
a pair of outrigger slots provided in said rail support platform; and
an outrigger having an outrigger shaft inserted in one of said pair of outrigger slots and an outrigger plate carried by said outrigger shaft.

18. The lure trolling device of claim 17 further comprising a clip attachment hook carried by said first rail support, a quick release clip attached to said clip attachment hook, a clip ring detachably attached to said quick release clip, a swivel attached to said clip ring and a line clip attached to said swivel.

19. The lure trolling device of claim 17 further comprising a third rail support extending from said end panel and wherein said rail is carried by said third rail support.

20. The lure trolling device of claim 17 further comprising a skirt carried by said tail hook.
